(19) United States
(12) Patent Application Publication
(10) Pub. No.: US 2026/0322958 A1
(43) Pub. Date: Oct. 15, 2026

(54) CORRECTION METHOD AND PROGRAM

(71) Applicant: SEIKO EPSON CORPORATION, Tokyo (JP)

(72) Inventor: Yutaro IIJIMA, MATSUMOTO-SHI (JP)

(21) Appl. No.: 19/644,120

(22) Filed: Apr. 10, 2026

(30) Foreign Application Priority Data
Apr. 11, 2025 (JP) 2025-065542

(51) Int. Cl. H04N 9/31

(52) U.S. Cl. CPC H04N 9/3185; H04N 9/3182

(57) ABSTRACT

When a rotation operation of the projection apparatus is detected based on the output from a gyro sensor, a controller of a projection apparatus calculates the amount of the rotation of the projection apparatus based on the output from the gyro sensor; calculates second posture information on a posture of a second projection receiving surface based on first posture information on a posture of a first projection receiving surface stored in a storage of the projection apparatus and the amount of the rotation of the projection apparatus; generates a correction parameter used to correct a shape of the projection image based on the calculated second posture information; and causes the projection apparatus to project the projection image having a shape corrected based on the correction parameter onto the second projection receiving surface.

The present application is based on, and claims priority from JP Application Serial Number 2025-065542, filed Apr. 11, 2025, the disclosure of which is hereby incorporated by reference herein in its entirety.

### BACKGROUND

### 1. Technical Field

The present disclosure relates to a correction method and a program.

### 2. Related Art

In related art, there is a known technology for determining a normal vector with respect to a projection receiving surface based on the distance to the projection receiving surface measured with a distance sensor and correcting a projection image by using the determined normal vector.

For example, WO 2022/193560 discloses a projector that acquires information on the depths of multiple light points on a projection receiving surface by using a time-of-flight (ToF) sensor and determines a normal vector with respect to the projection receiving surface based on multiple pieces of the acquired depth information. The projector disclosed in WO 2022/193560 acquires information on the amount of offset of the projector based on the determined normal vector with respect to the projection receiving surface, and corrects a projection image based on the acquired offset information.

WO 2022/193560 is an example of the related art.

There is, however, a case where the posture of a projection apparatus is changed, for example, the projection apparatus is rotated, so that the projection image is projected onto a projection receiving surface different from the projection receiving surface onto which the projection image was projected last time. For example, when indoor walls or an indoor ceiling are used as the projection receiving surface, the projection receiving surface may be changed from a wall to an adjacent wall or from a wall to the ceiling. When the projection receiving surface onto which the projection apparatus projects the projection image is changed, it is necessary to measure the posture and distance of the projection apparatus with respect to the projection receiving surface again, or to calculate the normal vector with respect to the projection receiving surface again, so that there is a concern that it takes time until the projection apparatus corrects the projection image to be projected.

### SUMMARY

A correction method according to an aspect of the present disclosure is a correction method causing a processor provided in a projection apparatus configured to project a projection image onto a projection receiving surface to: calculate, when a rotation operation of the projection apparatus is detected based on an output from a first sensor provided in the projection apparatus, an amount of the rotation of the projection apparatus based on the output from the first sensor; determine whether the projection receiving surface is changed from a first projection receiving surface to a second projection receiving surface different from the first projection receiving surface; calculate second posture information on a posture of the second projection receiving surface based on first posture information on a posture of the first projection receiving surface stored in a storage of the projection apparatus and the amount of the rotation of the projection apparatus; generate a correction parameter used to correct a shape of the projection image based on the calculated second posture information; and cause the projection apparatus to project the projection image having a shape corrected based on the correction parameter onto the second projection receiving surface.

A non-transitory computer-readable storage medium storing a program according to an aspect of the present disclosure is a non-transitory computer-readable storage medium storing a program causing a processor provided in a projection apparatus configured to project a projection image onto a projection receiving surface to: calculate, when a rotation operation of the projection apparatus is detected based on an output from a first sensor provided in the projection apparatus, an amount of the rotation of the projection apparatus based on the output from the first sensor; determine whether the projection receiving surface is changed from a first projection receiving surface to a second projection receiving surface different from the first projection receiving surface; calculate second posture information on a posture of the second projection receiving surface based on first posture information on a posture of the first projection receiving surface stored in a storage of the projection apparatus and the amount of the rotation of the projection apparatus; generate a correction parameter used to correct a shape of the projection image based on the calculated second posture information; and cause the projection apparatus to project the projection image having a shape corrected based on the correction parameter onto the second projection receiving surface.

### BRIEF DESCRIPTION OF THE DRAWINGS

FIG. 1 is a block diagram showing the configuration of a projection apparatus according to an embodiment.

FIG. 2 shows the configuration of a projector.

FIG. 3 shows multiple measurement positions on a projection receiving surface.

FIG. 4 shows the configuration of a light receiver provided in a distance sensor.

FIG. 5 shows an example of a depth information map and an intensity information map.

FIG. 6 shows a state in which the projection apparatus projects a projection image onto a first projection receiving surface.

FIG. 7 shows a state in which the projection apparatus projects a projection image onto a second projection receiving surface.

FIG. 8 is a flowchart showing the operation of the projection apparatus.

FIG. 9 shows a rotation matrix used to convert the coordinates between coordinate systems.

FIG. 10 shows a rotation matrix used to convert the coordinates between coordinate systems.

FIG. 11 shows normal vectors and the gravity vector with respect to the walls and the floor of a typical room.

### DESCRIPTION OF EMBODIMENTS

### 1. Configuration of Projection Apparatus According to Embodiment

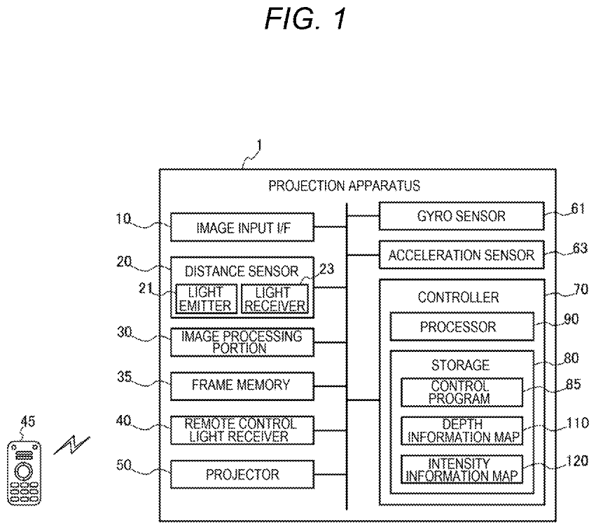

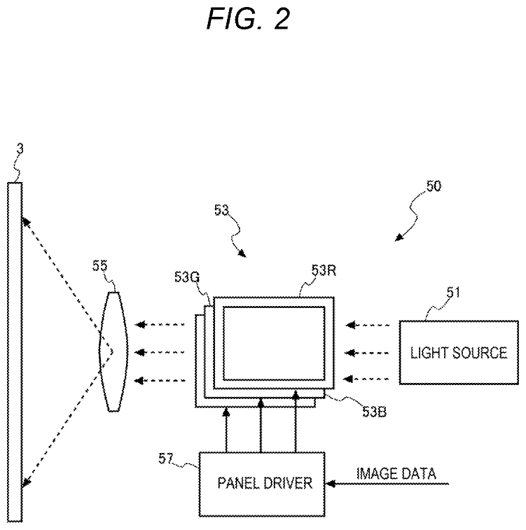

FIG. 1 is a block diagram showing the configuration of a projection apparatus 1 according to the embodiment, and FIG. 2 shows the configuration of a projector 50 provided in the projection apparatus 1. The configuration of the projection apparatus 1 will be described with reference to FIGS. 1 and 2.

The projection apparatus 1 includes an image input interface 10, a distance sensor 20, an image processing portion 30, a frame memory 35, a remote control light receiver 40, the projector 50, a gyro sensor 61, an acceleration sensor 63, and a controller 70. An interface is hereinafter abbreviated to I/F. The gyro sensor 61 corresponds to a first sensor, and the distance sensor 20 corresponds to a second sensor.

The image input I/F 10 is an interface to which an image signal transmission cable can be coupled, such as an high-definition multimedia interface (HDMI) or a display port, and includes an interface circuit that conforms to a predetermined communication standard. HDMI is a registered trademark. An image signal supplied from an external apparatus that is not shown such as a personal computer is input to the image input I/F 10. The image input I/F 10 outputs image data contained in the input image signal to the image processing portion 30.

The distance sensor 20 measures the distance to a measurement target. The distance sensor 20 includes a light emitter 21, which radiates radiation light, and a light receiver 23 including multiple light receiving elements that receive reflected light that is the radiation light reflected off a projection receiving surface 3. The distance sensor 20 irradiates the projection receiving surface 3, which is the measurement target, with the radiation light from a light emitting element provided in the light emitter 21 of the distance sensor 20, and receives the reflected light, which is the radiated radiation light reflected off the projection receiving surface 3, via the multiple light receiving elements. The distance sensor 20 measures the distance between the distance sensor 20 and multiple measurement positions on the projection receiving surface 3 based on the result of the reception of the reflected light via the multiple light receiving elements, and outputs sensor data indicating the result of the measurement to the controller 70. The controller 70 causes a storage 80, which will be described later, to store the sensor data input from the distance sensor 20. The present embodiment will be described with reference to a case where a ToF sensor is used as the distance sensor 20, but the distance sensor 20 may be another sensor such as a light-detection-and-ranging (LiDAR) sensor.

The light receiver 23 has a configuration in which the multiple light receiving elements are regularly arranged at a light receiving surface. The lateral direction of the light receiving surface is defined as an x-axis, and the longitudinal direction of the light receiving surface is defined as a y-axis. The light receiver 23 includes six light receiving elements in each of the x-axis direction and the y-axis direction. The number of the light receiving elements provided in the light receiver 23, that is, the resolution thereof is therefore six elements×six elements.

The frame memory 35 is coupled to the image processing portion 30. The frame memory 35 has multiple banks. The banks each have a storage capacity that allows image data corresponding to one frame to be written into the bank. The frame memory 35 is configured, for example, with a synchronous dynamic random access memory (SDRAM). The image processing portion 30 loads the image data input from the image input I/F 10 into the frame memory 35.

The image processing portion 30 performs image processing on the image data loaded into the frame memory 35. Examples of the image processing performed by the image processing portion 30 may include resolution conversion or resizing, distortion correction, shape correction, digital zooming, and adjustment of the tint and luminance of an image. The image processing portion 30 performs processing specified by the controller 70, and performs the processing by using a parameter input from the controller 70 as necessary. The image processing portion 30 can, of course, perform some of the multiple types of image processing described above in combination. The image processing portion 30 reads, from the frame memory 35, the image data loaded into a bank selected by the controller 70 and outputs the read image data to the projector 50.

The image processing portion 30 and the frame memory 35 are each configured, for example, with an integrated circuit. Examples of the integrated circuit may include a large scale integration (LSI) circuit, an application specific a integrated circuit (ASIC), programmable logic device (PLD), a field-programmable gate array (FPGA), a system-on-a-chip (SoC), and the like. The integrated circuit may include an analog circuit as a portion of the configuration thereof, or the controller 70 and the integrated circuit may be combined with each other.

The remote control light receiver 40 receives an infrared signal transmitted from a remote control 45. The remote control 45 includes multiple buttons such as a power button, a source switching button, a volume button, a projection start button, and a projection end button. The remote control 45 transmits an infrared signal corresponding to a button operated by a user to the projection apparatus 1. The remote control light receiver 40 outputs an operation signal corresponding to the received infrared signal to the controller 70. The operation signal is a signal corresponding to a button of the remote control 45 operated by the user.

FIG. 2 shows the configuration of the projector 50.

The configuration of the projector 50 will now be described with reference to FIG. 2.

The projector 50 modulates light output from a light source 51 to generate image light, enlarges and projects the generated image light via an optical unit 55. The projector 50 includes the light source 51, three liquid crystal panels 53R, 53G, and 53B serving as light modulators, the optical unit 55, and a panel driver 57. The liquid crystal panels 53R, 53G, and 53B provided in the projector 50 may be hereinafter collectively referred to as liquid crystal panels 53.

The light source 51 includes a discharge-type light source lamp such as an ultrahigh-pressure mercury lamp or a metal halide lamp, or a solid-state light source such as a light emitting diode or a semiconductor laser. The light output from the light source 51 is incident on the liquid crystal panels 53. The liquid crystal panels 53R, 53G, and 53B are each configured, for example, with a transmissive liquid crystal panel in which a liquid crystal material is encapsulated between a pair of transparent substrates. The liquid crystal panel 53R modulates red light, the liquid crystal panel 53G modulates green light, and the liquid crystal panel 53B modulates blue light. Each of the liquid crystal panels has a pixel region including multiple pixels arranged in a matrix, and is configured to apply a drive voltage to the liquid crystal material on a pixel basis.

The image data output by the image processing portion 30 is input to the panel driver 57. The panel driver 57 applies a drive voltage according to the input image data to each of the pixels in the pixel region to set the pixel to have light transmittance according to the image data. The light output from the light source 51 is modulated on a pixel basis when passing through the pixel regions of the liquid crystal panels 53R, 53G, and 53B, so that image light corresponding to the image data is formed on a color light basis. The multiple types of thus formed color image light are combined with one another on a pixel basis by a light combining system that is not shown into image light representing a color image. The optical unit 55 includes a projection lens, enlarges the image light modulated by the liquid crystal panels 53R, 53G, and 53B, and projects the enlarged image light onto the projection receiving surface 3.

Returning to FIG. 1, the description of the configuration of the projection apparatus 1 will be resumed.

The gyro sensor 61 measures an angular velocity that is the amount of change in the angle of the projection apparatus 1 per unit period in the direction of each of three axes, the x-axis, the y-axis, and a z-axis orthogonal to each other, and outputs sensor data indicating the result of the measurement to the controller 70.

The acceleration sensor 63 measures acceleration of the projection apparatus 1 in the direction of each of the three axes, the x-axis, the y-axis, and the z-axis, and outputs sensor data indicating the result of the measurement to the controller 70.

The controller 70 is a computer apparatus including the storage 80 and a processor 90.

The storage 80 includes at least a nonvolatile semiconductor memory. The storage 80 may include a volatile semiconductor memory or an auxiliary storage device in addition to the nonvolatile semiconductor memory. The storage 80 stores a control program 85, the sensor data indicating a result of the measurement performed by the distance sensor 20, a depth information map 110, an intensity information map 120, and various setting data. The storage 80 stores information on a normal vector and a gravity vector. The normal vector and the gravity vector stored in the storage 80 are those with respect to the projection receiving surface 3 determined when the shape of a projection image is corrected. The depth information map 110 and the intensity information map 120 will be described later.

The processor 90 is an arithmetic processing device including a central processing unit (CPU) or a micro-processing unit (MPU). The processor 90 may be configured with a single processor or multiple processors. The processor 90 may instead be configured with an SoC integrated with a portion or the entirety of the storage 80 or any other circuit. The processor 90 may be a combination of a CPU that executes a program and a digital signal processor (DSP) that performs predetermined arithmetic processing. Furthermore, all functions of the processor 90 may be implemented in hardware, or a programmable device may be used to realize the functions.

### 2. Distance Sensor

The sensor data indicating a result of the measurement performed by the distance sensor 20 will first be described.

The sensor data output by the distance sensor 20 contains depth information DI and intensity information SI. The depth information DI is information indicating distances from the distance sensor 20 to a plurality of measurement positions on the projection receiving surface 3. The intensity information SI is information indicating the received light intensity of the reflected light received by the distance sensor 20. The reflected light is the radiation light radiated by the distance sensor 20 and reflected off the projection receiving surface 3. The sensor data further contains information on the angle of incidence of the reflected light incident on the light receiving elements.

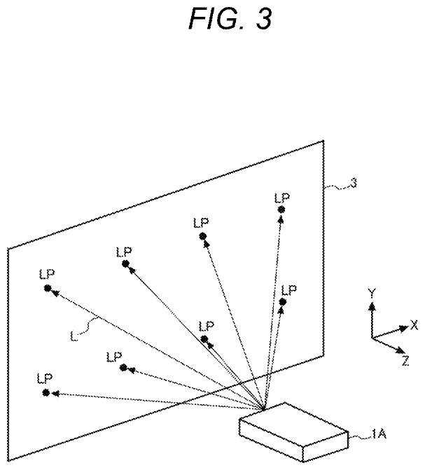

FIG. 3 shows the multiple measurement positions on the projection receiving surface 3.

FIG. 3 shows a state in which the projection apparatus 1 and the projection receiving surface 3 are installed in an XYZ coordinate system, which is a world coordinate system. The Y-axis of the XYZ coordinate system corresponds to the vertical direction, and the X-axis and the Z-axis correspond to the horizontal direction. The optical axis of the projection apparatus 1 is substantially parallel to the Z-axis. The optical axis of the projection apparatus 1 is the optical axis of the projection lens provided in the optical unit 55. Note that the term “being substantially parallel” means being parallel with an error that falls within an allowable range. When the distance sensor 20 is a ToF sensor, the distance sensor 20 irradiates the multiple measurement positions on the projection receiving surface 3 with multiple line laser beams L. The multiple line laser beams L with which the projection receiving surface 3 is irradiated form multiple light points LP on the projection receiving surface 3. The positions on the projection receiving surface 3 where the multiple light points LP are formed correspond to the multiple measurement positions. The distance sensor 20 outputs the depth information DI indicating the multiple distances from the distance sensor 20 to the multiple light points LP formed on the projection receiving surface 3 based on a period from the time at which the distance sensor 20 radiates the line laser beams L to the time at which the multiple light receiving elements provided in the distance sensor 20 detect reflected light from the multiple light points LP. FIG. 3 shows a case where the light points LP are formed at 8 positions out of 36 positions on the projection receiving surface 3, which is the largest number of positions at which the distance sensor 20 can perform the detection.

The distance sensor 20 may irradiate the projection receiving surface 3 with planar laser light from a surface emitting laser instead of irradiating the projection receiving surface 3 with the multiple linear laser beams L as described above. In this case, the multiple light receiving elements discretely disposed in the light receiver 23 of the distance sensor 20 sense the reflected light from the projection receiving surface 3.

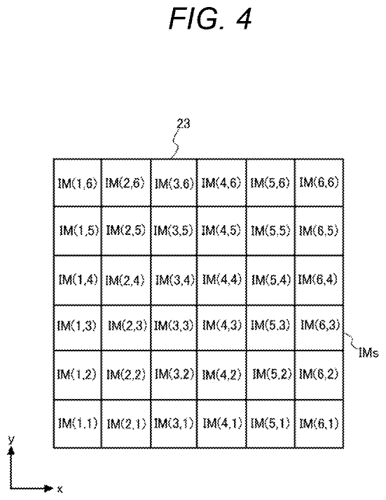

FIG. 4 shows the configuration of the multiple light receiving elements provided in the light receiver 23 of the distance sensor 20. The distance sensor 20 has a configuration in which six light receiving elements are regularly arranged in each of the x-axis direction and the y-axis direction, as shown in FIG. 4. The multiple light receiving elements provided in the light receiver 23 are collectively referred to as an element group IMs. The element group IMs is configured with 36 light receiving elements IM(1, 1) to IM(6, 6), as shown in FIG. 4. Note that the numbers in the parentheses are identification numbers used to identify the light receiving elements arranged in the x-axis direction and the y-axis direction. In FIG. 4, the lower left light receiving element is referred to as IM(1,1), and the upper right light receiving element is referred to as IM(6, 6). The light receiving elements arranged in the same row as the IM(1, 1) are assigned the same identification number indicating the position in the y-axis direction, such as IM(2,1), IM(3,1), IM(4,1), IM(5,1), and IM(6,1). The light receiving elements arranged in the same column as the IM(1, 1) are assigned the same identification number indicating the position in the x-axis direction, such as IM(1,2), IM(1, 3), IM(1, 4), IM(1,5), and IM(1,6). The same applies to the other light receiving elements disposed at the light receiving surface.

Let n be a variable indicating the number of times the distance sensor 20 performs the measurement. Note that n is any natural number. The controller 70 acquires the sensor data from the distance sensor 20 n times, which are multiple times. That is, the sensor data measured at multiple different points in time are acquired. The sensor data from the 36 light receiving elements produced in the first measurement is referred to as a first frame, and the sensor data produced in the n-th measurement is referred to as an n-th frame.

The depth information from the light receiving element IM(1, 1) in the first frame is referred to as DI(1, 1, 1), and the depth information from the light receiving element IM(1, 1) in the n-th frame is referred to as DI(1, 1, n). The first and second numerals out of the numerals shown in the parentheses are identification numbers used to identify the light receiving elements arranged in the x-axis direction and the y-axis direction, and the third numeral is an identification number used to identify the frame. Similarly, the intensity information SI from the light receiving element IM(1,1) in the first frame is referred to as SI(1, 1, 1), and the intensity information SI from the light receiving element IM(1, 1) in the n-th frame is referred to as SI(1, 1, n).

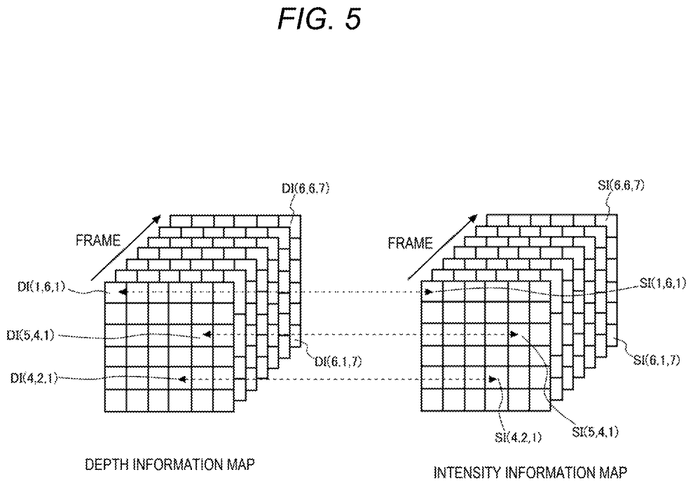

FIG. 5 shows a depth information map 110 and an intensity information map 120 generated by the controller 70. The controller 70 generates the depth information map 110 and the intensity information map 120 based on the sensor data input from the distance sensor 20.

The depth information map 110 is configured with n frames from the first frame to the n-th frame. The depth information map 110 of the first frame contains the depth information DI(1, 1, 1) to DI(6, 6, 1) from the light receiving elements IM(1, 1) to IM(6, 6) in the first frame. The depth information map 110 of the second frame contains the depth information DI(1, 1, 2) to DI(6, 6, 2) from the light receiving elements IM(1,1) to IM(6, 6) in the second frame. The same applies to the depth information maps 110 of the third frame to the n-th frame.

The intensity information map 120 is configured with n frames from the first frame to the n-th frame. The intensity information map 120 of the first frame contains the intensity information SI(1, 1, 1) to SI(6, 6, 1) from the light receiving elements IM(1,1) to IM(6, 6) in the first frame. The intensity information map 120 of the second frame contains the intensity information SI(1, 1, 2) to SI(6, 6, 2) from the light receiving elements IM(1,1) to IM(6, 6) in the second frame. The same applies to the third frame to the n-th frame.

### 3. Operation of Projection Apparatus

The operation of the projection apparatus 1 will next be described.

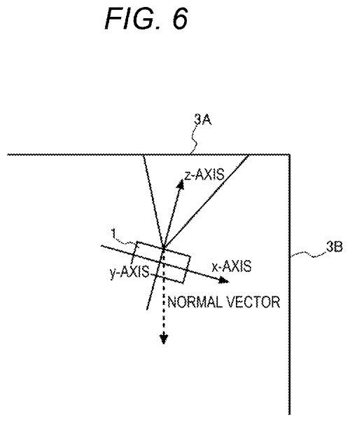

FIG. 6 shows a state in which the projection apparatus 1 projects a projection image onto a first projection receiving surface 3A.

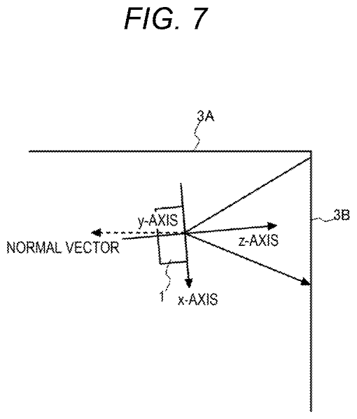

FIG. 7 shows a state in which the projection apparatus 1 projects a projection image onto a second projection receiving surface 3B.

In the examples shown in FIGS. 6 and 7, the first projection receiving surface 3A and the second projection receiving surface 3B are wall surfaces adjacent to each other in the same room. The first projection receiving surface 3A and the second projection receiving surface 3B may be collectively referred to as the projection receiving surface 3. It is assumed that the z-axis extends in the direction of the optical axis of the projection lens provided in the projection apparatus 1, that the y-axis extends in the vertical direction of the projection apparatus 1, and that the x-axis extends in the direction orthogonal to the z-axis and the y-axis. Note that the wall surfaces adjacent to each other in the same room include wall surfaces adjacent to each other with a pillar or a beam interposed therebetween.

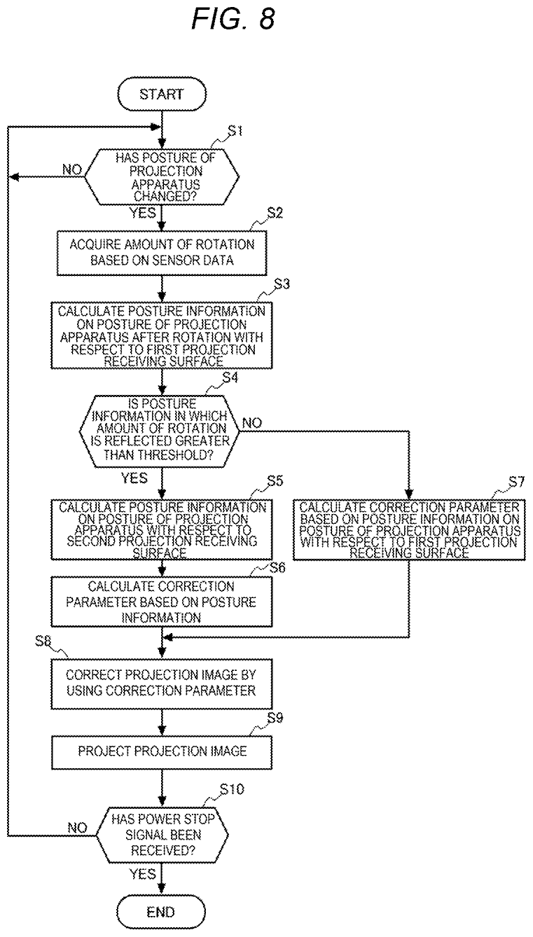

It is assumed that the user rotates the projection apparatus 1 from the state in which the projection apparatus 1 projects the projection image onto the first projection receiving surface 3A in a way that the z-axis, which extends in the direction of the optical axis of the projection apparatus 1, points to the second projection receiving surface 3B. The operation of the controller 70 at the situation described above will be described with reference to the flowchart shown in FIG. 8.

The controller 70 first determines whether the posture of the projection apparatus 1 has changed based on the sensor data acquired from the gyro sensor 61 (step S1). When the controller 70 determines that the posture of the projection apparatus has not changed (NO in step S1), the controller 70 carries out the process in step S1 again.

When the controller 70 determines that the posture of the projection apparatus 1 has changed (YES in step S1), the controller 70 calculates the amount of the rotation of the projection apparatus 1 after the detection of the change in the posture based on the sensor data acquired from the gyro sensor 61 and the sensor data stored in the storage 80 (step S2). The amount of the rotation corresponds to a change from the state in which the projection apparatus 1 is installed when the shape of the projection image was corrected last time. The sensor data stored in the storage 80 is sensor data measured in the state in which the projection apparatus 1 is installed when the shape of the projection image is corrected. Expression (1) below shows a determinant indicating the amount of the rotation.

$$R = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) \qquad ( 1 )$$

The controller 70 then reads posture information on the posture of the projection apparatus 1 with respect to the first projection receiving surface 3A that has been determined when the shape of the projection image was corrected last time. The posture information refers, for example, to a normal vector or a gravity vector with respect to the projection receiving surface. In addition, the posture information refers to all pieces of information relating to the posture of the projection apparatus with respect to the projection receiving surface, such as a rotation matrix and an angle, which are mutually convertible pieces of information on the posture. An example in which a normal vector and a gravity vector are used as the posture information will be described below.

The controller 70 reflects the amount of the rotation calculated in step S2 in the read first normal vector and the gravity vector, and determines a first normal vector and a gravity vector after the rotation of the projection apparatus 1 (step S3). The first normal vector and the gravity vector are used as variables indicating the posture information on the posture of the projection apparatus 1 after the rotation. In the case where a rotation matrix Rs1p1 has been read, the amount of the rotation is reflected in the rotation matrix Rs1p1, and a rotation matrix Rs1p2, which indicates the projection apparatus 1 after the rotation with respect to the first projection receiving surface 3A, is determined. To simplify the description in the embodiment, it is assumed that the optical axis of the projection lens provided in the projection apparatus 1 before rotation is substantially parallel to the normal vector with respect to the first projection receiving surface 3A, but the optical axis of the projection lens provided in the projection apparatus 1 before rotation may not be substantially parallel to the normal vector with respect to the first projection receiving surface 3A. In this case, however, it is assumed that the projection apparatus 1 stores the relative coordinates between the lens coordinate system in the projection apparatus 1 before rotation and the coordinate system of the first projection receiving surface 3A. Note that the term “being substantially parallel” means being parallel with an error that falls within an allowable range. The normal vector with respect to the first projection receiving surface 3A can therefore be used as the posture information indicating the posture of the projection apparatus 1 with respect to the first projection receiving surface 3A.

Expression (2) shows the first normal vector with respect to the first projection receiving surface 3A determined when the shape of the projection image was corrected last time, and Expression (3) shows the gravity vector. The first normal vector and the gravity vector with respect to the first projection receiving surface 3A determined when the shape of the projection image was corrected are an example of first posture information. Note that the first posture information may be a rotation matrix used to convert the coordinate system of the first projection receiving surface 3A into the coordinate system of the projection apparatus 1 before rotation, or information on the angle of the first projection receiving surface in the projector coordinate system provided when the shape of the projection image is corrected.

Nₚ₁ₛ₁=(nₚ₁ₛ₁_{ₓ},nₚ₁ₛ₁_{_{y}},nₚ₁ₛ₁_{_{z}}) (2)

Gₚ₁=(gₚ₁_{ₓ},gₚ₁_{_{y}},gₚ₁_{_{z}}) (3)

Out of the subscripts of an x component np1s1x, a y component np1s1y, and a z component np1s1z of a variable Np1s1 indicating the first normal vector, “p1” indicates the projection apparatus 1 before rotation, and “s1” indicates the first projection receiving surface 3A.

The subscript “p1” of an x component gp1x, a y component gp1y, and a z component gp1z of a gravity vector Gp1 also indicates the projection apparatus 1 before rotation.

Expression (4) shows a normal vector that is the first normal vector expressed by Expression (2) but rotated by the amount of rotation calculated in step S2, and Expression (5) shows a gravity vector that is the gravity vector expressed by Expression (3) but rotated by the amount of rotation calculated in step S2. The normal vector expressed by Expression (4) is referred to as a first normal vector after rotation.

$${N}_{p 2 s 1} = ( {n}_{p 2 s {1}_{x}} , {n}_{p 2 s {1}_{y}} , {n}_{p 2 s {1}_{z}} ) = {( {R}_{r} {N}_{p 1 s 1}^{T} )}^{T} \qquad ( 4 )$$

Gₚ₂=(gₚ₂_{ₓ},gₚ₂_{_{y}},gₚ₂_{_{z}})=(RᵣG_{P1}^{T}) (5)

The first normal vector after rotation is a normal vector in a case where the projection apparatus 1 has been rotated and the projection receiving surface 3 is the first projection receiving surface 3A. Out of the subscripts of an x component np2s1x, a y component np2s1y, and a z component np2s1z of a variable Np2s1 indicating the first normal vector after rotation, “p2” indicates the projection apparatus 1 after rotation, and “s1” indicates the first projection receiving surface 3A.

The subscript “p2” of an x component gp2x, a y component gp2y, and a z component gp2z of a gravity vector Gp2 indicates the projection apparatus 1 after rotation.

As another method, the controller 70 may calculate a variable indicating the current posture of the projection apparatus 1 by using the rotation matrix expressed by Expression (1).

Rₛ₁ₚ₂=Rₚ₁ₚ₂Rₛ₁ₚ₁=RᵣRₛ₁ₚ₁ (6)

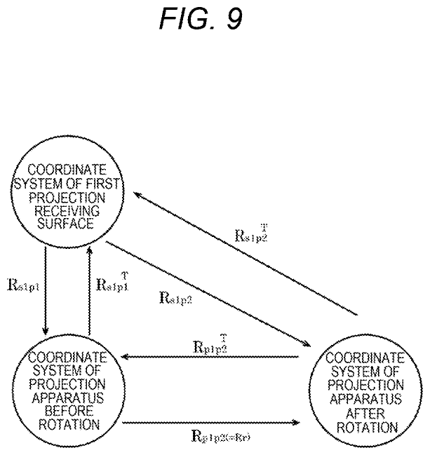

FIG. 9 shows a rotation matrix used to convert the coordinates between coordinate systems. In more detail, FIG. 9 shows a rotation matrix used to convert the coordinates between the coordinate system of the first projection receiving surface 3A, the coordinate system of the projection apparatus 1 before rotation, and the coordinate system of the projection apparatus 1 after rotation.

The symbol Rs1p2 in Expression (6) represents a rotation matrix used to convert the coordinate system of the first projection receiving surface 3A into the coordinate system of the projection apparatus 1 after rotation. Out of the subscripts “s1p2” of Rs1p2, “s1” indicates the first projection receiving surface 3A, and “p2” indicates the projection apparatus 1 after rotation.

The symbol Rs1p1 in Expression (6) represents a rotation matrix used to convert the coordinate system of the first projection receiving surface 3A into the coordinate system of the projection apparatus 1 before rotation. Out of the subscripts “s1p1” of R, “s1” indicates the first projection receiving surface 3A, and “p1” indicates the projection apparatus 1 before rotation.

The symbol Rp1p2 shown in Expression (6) represents a rotation matrix used to convert the coordinate system of the projection apparatus 1 before rotation into the coordinate system of the projection apparatus 1 after rotation. The subscript “p1” of R indicates the projection apparatus 1 before rotation, and “p2” indicates the projection apparatus 1 after rotation.

The controller 70 then compares the first normal vector after rotation, which is the posture information in which the amount of rotation shown in Expression (4) is reflected, and the gravity vector in which the amount of rotation shown in Expression (5) is reflected, with a threshold set in advance (step S4). Note that the first normal vector and the gravity vector are each compared with a threshold in the embodiment, and the determination process in step S4 may be carried out by comparing the first normal vector and a parameter calculated from the gravity vector, such as a rotation matrix, each with a threshold, or the determination process in step S4 may be carried out by comparing a second normal vector and a parameter calculated from the gravity vector, such as a rotation matrix, each with a threshold.

For example, when the first normal vector after rotation that reflects the amount of rotation is greater than the threshold (YES in step S4), the controller 70 determines that the projection receiving surface 3, onto which the projection apparatus 1 projects the projection image, has been changed from the first projection receiving surface 3A to the second projection receiving surface 3B. In this case, the controller 70 calculates the posture information on the posture of the projection apparatus 1 with respect to the second projection receiving surface 3B (step S5). The posture information calculated in step S5 is second posture information. The second posture information in the embodiment contains the second normal vector and the gravity vector in the projector coordinate system after the rotation. The second posture information may contain a rotation matrix used to convert the coordinate system of the second projection receiving surface 3B into the coordinate system of the projection apparatus 1 after rotation, information on the angles of the second normal vector and the gravity vector in the projector coordinate system after rotation, or a rotation vector.

The controller 70 then generates a correction parameter used to correct the shape of the projection image to be projected onto the projection receiving surface 3 based on the second normal vector contained in the posture information calculated in step S5 (step S6).

When the first normal vector after rotation is smaller than or equal to the threshold (NO in step S4), the controller 70 determines that the projection receiving surface 3, onto which the projection apparatus 1 projects the projection image, is still the first projection receiving surface 3A. In this case, the controller 70 generates a correction parameter used to correct the shape of the projection image to be projected onto the projection receiving surface 3 based on the first normal vector contained in the posture information calculated in step S3 (step S7).

Having generated the correction parameter, the controller 70 corrects the shape of the projection image by using the generated correction parameter (step S8), and displays the projection image having the corrected shape on the projection receiving surface 3 (step S9). The controller 70 determines whether a power stop signal has been received from the remote control light receiver 40 (step S10). When the controller 70 determines that the power stop signal has been received (YES in step S10), the controller 70 terminates the operation. When the controller 70 determines that the power stop signal has not been received (NO in step S10), the controller 70 carries out the process in step S1 again.

As a method for simplistically determining whether the projection receiving surface 3 has been changed from the first projection receiving surface 3A to the second projection receiving surface 3B, when the projection apparatus 1 is not rotated in the roll direction, the yaw angle and the pitch angle of the projection apparatus 1 may be determined, and it may be determined whether at least one of the determined yaw angle and pitch angle is greater than a threshold. The yaw angle is an angle of rotation around the y-axis, and the pitch angle is an angle of rotation around the x-axis. Expression (7) shows the yaw angle, and Expression (8) shows the pitch angle.

$$θ = {tan}^{- 1} ( \frac{{n}_{p 2 s {1}_{x}}}{{n}_{p 2 s {1}_{z}}} ) \qquad ( 7 )$$

$$φ = {tan}^{- 1} ( \frac{{n}_{p 2 s {1}_{y}}}{{n}_{p 2 s {1}_{z}}} ) \qquad ( 8 )$$

The controller 70 compares each of the yaw angle shown in Expression (7) and the pitch angle shown in Expression (8) with the threshold. In the present embodiment, π/2 is used as the threshold. When at least one of the yaw angle expressed by Expression (7) and the pitch angle expressed by Expression (8) is greater than the threshold, the controller 70 determines that the projection receiving surface 3, onto which the projection apparatus 1 performs projection, has been changed from the first projection receiving surface 3A to the second projection receiving surface 3B.

When the projection apparatus 1 is rotated in the roll direction, the posture of the projection apparatus 1 viewed from the coordinate system of the first projection receiving surface 3A may be determined based on both the gravity vector and the first normal vector after rotation, and it may be determined whether the posture at this point in time exceeds a certain threshold. The threshold used in the determination may have hysteresis.

The operation of the controller 70 calculating the posture of the projection apparatus 1 with respect to the second projection receiving surface 3B in step S5 will next be described. In the following operation, the controller 70 carries out processes on the assumption that the relationship between the walls in the room and the relationship between the walls and the ceiling are known.

For example, when the relationship between the adjacent planes is provided in advance in the form of the amount of rotation, the controller 70 reflects the provided amount of rotation in each of the vectors or the rotation matrix to determine a new vector or rotation matrix at the projection receiving surface 3 after rotation.

For example, it is assumed that the rotation from the first projection receiving surface 3A to the second projection receiving surface 3B is provided by the rotation matrix shown in Expression (9).

$${R}_{s 1 s 2} = ( \begin{matrix}{r}_{s 1 s {2}_{11}} & {r}_{s 1 s {2}_{12}} & {r}_{s 1 s {2}_{13}} \\ {r}_{s 1 s {2}_{21}} & {r}_{s 1 s {2}_{22}} & {r}_{s 1 s {2}_{23}} \\ {r}_{s 1 s {2}_{31}} & {r}_{s 1 s {2}_{32}} & {r}_{s 1 s {2}_{33}}\end{matrix} ) \qquad ( 9 )$$

Out of the subscripts “s1s2” of Rs1s2 shown in Expression (9), “s1” indicates the first projection receiving surface 3A, and “s2” indicates the second projection receiving surface 3B.

Expression (10) below shows the first normal vector after rotation with respect to the first projection receiving surface 3A reflecting the amount of rotation.

$${N}_{p 2 s 1} = {( {R}_{s 1 p 2} {N}_{s 1 s 1}^{T} )}^{T} = {( {R}_{s 1 p 2} ( \begin{matrix}0 \\ 0 \\ 1\end{matrix} ) )}^{T} \qquad ( 10 )$$

The subscript “s1s1” of the first normal vector Ns1s1 after rotation expressed by Expression (10) means a normal vector viewed in the direction in which the first projection receiving surface 3A is viewed from the front. That is, the subscript “s1s1” means a state in which the normal vector with respect to the first projection receiving surface 3A is parallel to the optical axis of the projection lens provided in the projection apparatus 1. That is, Ns1s1 is a matrix expressed by Expression (11) below.

$${N}_{s 1 s 1} = {( \begin{matrix}0 \\ 0 \\ - 1\end{matrix} )}^{T} \qquad ( 11 )$$

A normal vector Np2s2 with respect to the second projection receiving surface 3B reflecting the amount of rotation of the projection apparatus 1 is determined by Expression (12) below.

$${N}_{p 2 s 2} = {( {R}_{s 1 p 2} {R}_{s 1 s 2}^{T} {N}_{s 2 s 2}^{T} )}^{T} = {( {R}_{s 1 p 2} {R}_{s 1 s 2}^{T} ( \begin{matrix}0 \\ 0 \\ - 1\end{matrix} ) )}^{T} \qquad ( 12 )$$

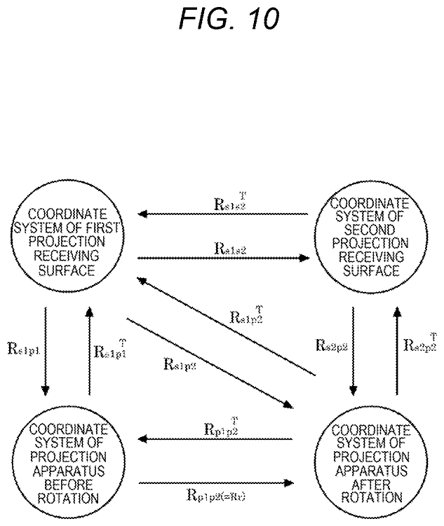

FIG. 10 shows a rotation matrix used to convert the coordinates between coordinate systems. In more detail, FIG. 10 shows a rotation matrix used to convert the coordinates between the coordinate system of the first projection receiving surface 3A, the coordinate system of the second projection receiving surface 3B, the coordinate system of the projection apparatus before rotation, and the coordinate system of the projection apparatus after rotation.

In Expression (12), Ns2s2 represents the second normal vector. The subscript “s2s2” of the second normal vector Ns2s2 means a normal vector viewed in the direction in which the second projection receiving surface 3B is viewed from the front. That is, the subscript “s2s2” means a state in which the normal vector with respect to the second projection receiving surface 3B is parallel to the optical axis of the projection lens provided in the projection apparatus 1. That is, Ns2s2 is a matrix expressed by Expression (13) below.

$${N}_{s 2 s 2} = {( \begin{matrix}0 \\ 0 \\ - 1\end{matrix} )}^{T} \qquad ( 13 )$$

The rotation matrix Rs1s2 expressed by Expression (12) is a rotation matrix used to convert the coordinate system of the second projection receiving surface 3B into the coordinate system of the first projection receiving surface 3A, as shown in FIG. 10.

The rotation matrix Rs1p2 expressed by Expression (12) is a rotation matrix used to convert the coordinate system of the first projection receiving surface 3A into the coordinate system of the projection apparatus 1 after rotation, as shown in FIG. 10.

The second normal vector Np2s2 is expressed by Expression (14) derived by Expressions (10) to (13). The second normal vector Np2s2 is a normal vector in a case where the projection apparatus 1 has been rotated and the projection receiving surface 3 is the second projection receiving surface 3B.

$$\begin{matrix}{N}_{p 2 s 2} = {( {R}_{s 1 p 2} {R}_{s 1 s 2}^{T} {N}_{s 2 s 2}^{T} )}^{T} \\ = {( {R}_{s 1 p 2} {R}_{s 1 s 2}^{T} {N}_{s 1 s 1}^{T} )}^{T} \\ = {( {R}_{s 1 p 2} {R}_{s 1 s 2}^{T} {R}_{s 1 p 2}^{T} {R}_{s 1 p 2} {N}_{s 1 s 1}^{T} )}^{T} \\ = {( {R}_{s 1 p 2} {R}_{s 1 p 2}^{T} {R}_{s 1 p 2}^{T} {N}_{p 2 s 1}^{T} )}^{T}\end{matrix} \qquad ( 14 )$$

Organizing the rotation matrix expressed by Expression (14) described above into Expression (15) allows the second normal vector Np2s2 after the rotation of the projection apparatus 1 to also be expressed by Expression (16). When the rotation matrix Rns1ns2 is determined, the normal vector with respect to the second projection receiving surface 3B can be determined from the first normal vector with respect to the first projection receiving surface 3A.

$${R}_{ns 1 ns 2} = {R}_{s 1 p 2} {R}_{s 1 s 2}^{T} {R}_{s 1 p 2}^{T} \qquad ( 15 )$$

$${N}_{p 2 s 2} = {( {R}_{ns 1 ns 2} {N}_{p 2 s 1}^{T} )}^{T} \qquad ( 16 )$$

The gravity vector will next be described.

Since the gravity vector indicates the same direction in the world coordinate system irrespective of the surface to which the gravity vector points, it is not necessary to recalculate the gravity vector.

When projection is performed onto the ceiling or the floor surface, the gravity vector is treated as a normal vector, and a video is corrected without correction of rotation in the roll direction. This is because the ceiling surface and the floor surface are perpendicular to gravity in many cases, in which case, the normal vector and the gravity vector coincide with each other.

However, when the projection receiving surface 3 is rotated from a wall to the ceiling, and when it is desired to perform roll correction based on a horizontal line on the wall, which is the projection receiving surface 3, the correction can be performed by converting the normal vector into the gravity vector. Specifically, the normal vector with respect to the wall surface is treated as the gravity vector as in Expression (17) below. The sign shown in Expression (17) is changed by the definition of the orientation of the normal. Strictly speaking, the normal vector is not the gravity vector, but treating the normal vector virtually as the gravity vector allows trapezoidal correction including horizontal-line-based roll correction of the wall surface to be performed with the same logic for the wall surface.

$${G}_{p 2} = - {N}_{p 2 s 1} = - {( {R}_{s 1 pa} {N}_{s 1 s 1}^{T} )}^{T} \qquad ( 17 )$$

$${R}_{s 2 p 2} = {R}_{s 1 p 2} {R}_{s 1 s 2}^{T} \qquad ( 18 )$$

Instead, the normal vector and the gravity vector may be determined and then the rotation matrix may be determined by using the normal vector and the gravity vector, or the rotation matrix may be determined and then the normal vector and the gravity vector may be determined by using the rotation matrix.

In any case, when the current posture of the projection apparatus 1 with respect to the second projection receiving surface 3B can be obtained by a vector, a rotation matrix, or the like, the trapezoidal correction can also be performed on the second projection receiving surface 3B.

As described above, when the amount of rotation between the projection receiving surfaces 3 is known, the normal vector, which is the current posture of the projection apparatus 1 with respect to the projection receiving surface 3, and the rotation matrix can be determined by using the rotation matrix. However, since it takes time and effort to determine the relationship between the surfaces in advance, the correction can be further simplified by providing a precondition, for example, that the surfaces are perpendicular to each other.

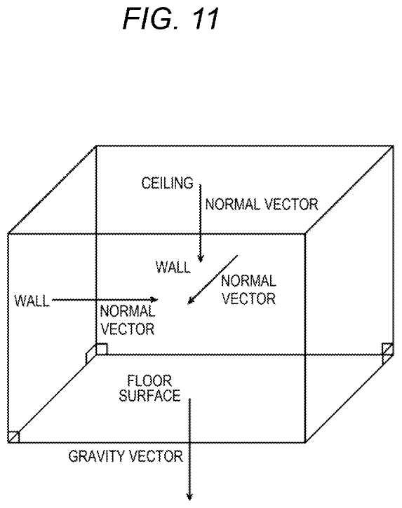

FIG. 11 shows normal vectors and the gravity vector with respect to the walls and the floor of a typical room.

In the case of a typical room, a wall and the ceiling adjacent to each other or a wall and the floor surface adjacent to each other are perpendicular to each other, the walls stand in parallel to the gravity vector, and the ceiling and the floor surface are perpendicular to the gravity vector, as shown in FIG. 11.

For example, when the projection receiving surface 3 is changed from a wall to another wall of the room, the second normal vector may be calculated by rotating the first normal vector by 90 degrees around the gravity vector as the axis of rotation. In this case, the second normal vector can be readily calculated, so that the time required to generate the correction parameter generated based on the second normal vector can be shortened. The period until the projection image having a corrected shape is projected onto the second projection receiving surface 3B can therefore be shortened, so that the user's convenience can be improved.

When the projection receiving surface 3 is changed from a wall to the ceiling or the floor surface of the room, the second normal vector may be calculated by rotating the first normal vector by 90 degrees around a vector perpendicular to the first normal vector and the gravity vector as the axis of rotation. Also in this case, the second normal vector can be readily calculated, so that the time required to generate the correction parameter generated based on the second normal vector can be shortened. The period until the projection image having a corrected shape is projected onto the second projection receiving surface 3B can therefore be shortened, so that the user's convenience can be improved.

When the projection receiving surface is rotated to an adjacent wall, the first normal vector may be rotated by 90 degrees around the gravity vector, and the gravity vector may remain as it is.

Expression (19) shows the rotation matrix, Expression (20) shows the first normal vector after rotation reflecting the amount of the rotation, and Expression (21) shows the gravity vector.

$${R}_{c} = ( \begin{matrix}{r}_{c 11} & {r}_{c 12} & {r}_{c 13} \\ {r}_{c 21} & {r}_{c 22} & {r}_{c 23} \\ {r}_{c 31} & {r}_{c 32} & {r}_{c 33}\end{matrix} ) \qquad ( 19 )$$

$${N}_{p 2 s 1} = {( {R}_{c} {N}_{p 2 s 1}^{T} )}^{T} \qquad ( 20 )$$

Gₚ₂=Gₚ₁ (21)

When it is assumed that the projection apparatus 1 is not inclined with respect to the horizontal plane, that is, the projection apparatus 1 is not rotated in the roll or pitch direction, the gravity vector and the y-axis of the projection apparatus 1 coincide with each other, so that the x component and the z component of the normal vector may be swapped, and the sign of the z component of a new vector may be reversed as in Expressions (22) and (23).

$${R}_{yaw} = ( \begin{matrix}cos ( \frac{π}{2} ) & 0 & sin ( \frac{π}{2} ) \\ 0 & 1 & 0 \\ - sin ( \frac{π}{2} ) & 0 & cos ( \frac{π}{2} )\end{matrix} ) = ( \begin{matrix}0 & 0 & 1 \\ 0 & 1 & 0 \\ - 1 & 0 & 0\end{matrix} ) \qquad ( 22 )$$

$${N}_{p 2 s 2} = {( {R}_{yaw} {N}_{p 2 s 1}^{T} )}^{T} = ( {n}_{p 2 s {1}_{z}} , {n}_{p 2 s {1}_{y}} , - {n}_{p 2 s {1}_{x}} ) \qquad ( 23 )$$

Also when it is not assumed that the projection apparatus 1 is not rotated in the roll or pitch direction, the second normal vector can be readily determined by calculating a vector perpendicular to the first normal vector and the gravity vector, for example, by using the outer product of the vectors.

When the projection receiving surface 3 is changed from a wall to the ceiling, the gravity vector and the normal vector coincide with each other, so that it is only necessary to swap the vectors and reverse the signs thereof, as shown by Expressions (24) and (25). When the direction of the normal vector is a direction toward the surface, the signs in Expressions (24) and (25) below are reversed. The same applies to a case where the projection receiving surface 3 is changed from the ceiling to a wall.

Nₐᵣ=Gₐ (24)

Gₐᵣ=−Nₐ (25)

Note that when the projection image is corrected with the initial state being the state in which the projection image is projected onto the ceiling, the gravity vector coincides with the normal vector, so that the roll correction is not typically performed. In this state, when the projection apparatus 1 is so rotated that the projection receiving surface 3 is changed from the ceiling to a wall, only the roll and pitch components of the projection image are corrected because information on the normal to the wall cannot be acquired.

The relationship between the projection receiving surface 3 before the rotation and the projection receiving surface 3 after the rotation has not been acquired by using the precondition that a wall and the ceiling adjacent to each other or a wall and the floor surface adjacent to each other are perpendicular to each other, that the walls are parallel to the gravity vector, and that the ceiling and the floor surface are perpendicular to the gravity vector. However, the relationship between a wall and the ceiling or between a wall and the floor surface can also be determined by using any of the sensors incorporated in the projection apparatus 1.

For example, Rs1p1 indicating the relationship between the projection apparatus 1 and the first projection receiving surface 3A before rotation and Rs2p2 indicating the relationship between the projection apparatus 1 and the second projection receiving surface 3B after rotation can be acquired by measuring the first projection receiving surface 3A and the second projection receiving surface 3B with the distance sensor 20 or the acceleration sensor 63. Instead, a camera may be incorporated in the projection apparatus 1, images of the first projection receiving surface 3A and the second projection receiving surface 3B may be captured with the camera, and Rs1p1 indicating the relationship between the projection apparatus 1 and the first projection receiving surface 3A before rotation and Rs2p2 indicating the relationship between the projection apparatus 1 and the second projection receiving surface 3B after rotation may be acquired based on the images captured with the camera.

The amount of rotation Rp1p2 before and after the rotation with respect to the projection apparatus 1 may be measured with the first sensor incorporated in the projection apparatus 1. The first sensor that detects the rotation of the projection apparatus 1 may, for example, be the gyro sensor 61, or an encoder of a rotation mechanism or an inertial measurement unit (IMU) attached to an enclosure of the projection apparatus 1. A value measured with any of the sensors can be used to calculate the amount of rotation Rs1s2 between the projection receiving surfaces 3 in accordance with Expression (26).

$${R}_{s 1 s 2} = {R}_{s 2 p 1}^{T} {R}_{p 1 p 2} {R}_{s 1 p 1} \qquad ( 26 )$$

Instead, a camera may be incorporated as a sensor in the projection apparatus 1, and the rotational relationship between two walls may be determined by simultaneously measuring the two walls with the camera or the ToF sensor, which is the distance sensor 20. Still instead, a camera or an LiDAR may be incorporated as a sensor in the projection apparatus 1, and the rotational relationship between the projection receiving surfaces 3 may be determined by detecting the situation of the room where the projection apparatus 1 is installed with the aid of a technology such as simultaneous localization and mapping (SLAM), which uses the sensor to grasp the surrounding situation.

In the embodiment described above, the first normal vector is rotated based on the amount of rotation calculated by the gyro sensor 61, and the rotated first normal vector is compared with the threshold to determine whether the projection receiving surface 3 has been changed from the first projection receiving surface 3A to the second projection receiving surface 3B.

As a method for determining whether the projection receiving surface 3 has been changed from the first projection receiving surface 3A to the second projection receiving surface 3B, depth information from the ToF sensor, which is the distance sensor 20 may be used.

It is assumed that the distance sensor 20 includes the light receiver 23 including, for example, 16 light receiving elements that form 4 pixels×4 pixels. When the projection receiving surface 3 is switched from a wall to an adjacent wall, at the corner of the boundary between the walls, the value of the depth information measured, for example, with the light receiving elements in the second and third columns is greater than the value of the depth information measured with the light receiving elements in the first and fourth columns. When such data is contained in the sensor data output by the ToF sensor, the controller 70 determines that the projection receiving surface 3 has been changed from the first projection receiving surface 3A to the second projection receiving surface 3B.

When the projection receiving surface 3 is changed from a wall to the ceiling, at the corner of the boundary between the wall and the ceiling, the value of the depth information measured with the light receiving elements in the second and third rows is greater than the value of the depth information measured with the light receiving elements in the first and fourth rows. When such data is contained in the sensor data output by the ToF sensor, the controller 70 determines that the projection receiving surface 3 has been changed from the first projection receiving surface 3A to the second projection receiving surface 3B.

The embodiment described above is a preferred embodiment of the present disclosure. The present disclosure is, however, not limited to the embodiment described above, and various modifications are conceivable to the extent that the modifications do not depart from the key points of the present disclosure.

For example, in the embodiment, the case where the transmissive liquid crystal panels are provided as the light modulators is presented by way of example, and the liquid crystal panels may instead be reflective liquid crystal panels. The light modulators may each have a configuration in which the liquid crystal panel is replaced with a digital mirror device. The light modulators may have a configuration in which the digital mirror devices and a color wheel are combined with each other. Besides the liquid crystal panels and the digital mirror devices, the light modulators may each have a configuration capable of modulating the light output by a light source.

Each of the functional portions of the projection apparatus 1 shown in FIG. 1 shows a functional configuration, and is not necessarily implemented in a specific form. That is, hardware individually corresponding to each of the functional portions is not necessarily required to be implemented, and a configuration in which one processor executes a program to realize the functions of multiple functional portions can, of course, be employed. Some of functions realized by software in the embodiment described above may be realized by hardware, and some of functions realized by hardware in the embodiment may be realized by software. In addition, the specific detailed configuration of each of the other portions of the projector can be freely changed to the extent that the change does not depart from the intent of the present disclosure.

The process units in the flowchart shown in FIG. 8 are process units into which the processes carried out by the projection apparatus 1 are divided in accordance with the contents of the primary processes to facilitate understanding of the processes. The present disclosure is not limited by how to divide the process units and the names thereof shown in the flowchart shown in FIG. 8. A process carried out by the projection apparatus 1 can be further divided into a larger number of process units in accordance with the content of the process, and the process units can each further be divided into a large number of processes. Furthermore, the process order of the flowchart described above is not limited to that shown in FIG. 8.

In the flowchart shown in FIG. 8, when the first normal vector after rotation reflecting the amount of rotation is greater than the threshold (YES in step S4), the controller 70 calculates the posture information on the posture of the projection apparatus 1 with respect to the second projection receiving surface 3B (step S5). Instead, the posture information on the posture of the projection apparatus 1 with respect to the second projection receiving surface 3B may be calculated in advance before the controller 70 executes step S4.

### 4. Summary of Present Disclosure

The present disclosure will be summarized below in the form of additional remarks.

### Additional Remark 1

A correction method causing a processor provided in a projection apparatus configured to project a projection image onto a projection receiving surface to: calculate, when a rotation operation of the projection apparatus is detected based on an output from a first sensor provided in the projection apparatus, an amount of the rotation of the projection apparatus based on the output from the first sensor; determine whether the projection receiving surface is changed from a first projection receiving surface to a second projection receiving surface different from the first projection receiving surface; calculate second posture information on a posture of the second projection receiving surface based on first posture information on a posture of the first projection receiving surface stored in a storage of the projection apparatus and the amount of the rotation of the projection apparatus; generate a correction parameter used to correct a shape of the projection image based on the calculated second posture information; and cause the projection apparatus to project the projection image having a shape corrected based on the correction parameter onto the second projection receiving surface.

In the correction method according to Additional Remark 1, when the rotation operation of the projection apparatus is detected, the amount of the rotation of the projection apparatus is calculated based on the output from the first sensor, the second posture information on the posture of the second projection receiving surface is calculated based on the first posture information on the posture of the first projection receiving surface stored in the storage of the projection apparatus and the amount of the rotation of the projection apparatus, and the correction parameter used to correct the shape of the projection image is generated based on the calculated second posture information. It is therefore unnecessary to calculate a second normal vector with respect to the second projection receiving surface based, for example, on the value measured with the sensor, so that the period required to project the projection image having the corrected shape onto the second projection receiving surface can be shortened, and the user's convenience can be improved accordingly.

### Additional Remark 2

The correction method according to Additional Remark 1, wherein determining whether the projection receiving surface is changed to the second projection receiving surface includes comparing the amount of the rotation of the projection apparatus calculated based on the output with a threshold, and determining that the projection receiving surface is changed to the second projection receiving surface when the amount of the rotation is greater than the threshold.

According to the correction method of Additional Remark 2, it is determined that the projection receiving surface has been changed to the second projection receiving surface when the amount of the rotation of the projection apparatus calculated based on the output from the first sensor is greater than the threshold. Whether the projection receiving surface has been changed from the first projection receiving surface to the second projection receiving surface can therefore be determined with the simplest possible configuration.

### Additional Remark 3

The correction method according to Additional Remark 1, wherein determining whether the projection receiving surface is changed to the second projection receiving surface includes determining whether the projection receiving surface is changed to the second projection receiving surface based on a distance to the projection receiving surface measured with a second sensor provided in the projection apparatus.

In the correction method according to Additional Remark 3, it is determined whether the projection receiving surface s changed to the second projection receiving surface based on the distance to the projection receiving surface measured with the second sensor provided in the projection apparatus. Whether the projection receiving surface has been changed from the first projection receiving surface to the second projection receiving surface can therefore be determined with the simplest possible configuration.

### Additional Remark 4

The correction method according to any one of Additional Remarks 1 to 3, wherein calculating the second posture information includes calculating the second posture information by reflecting the rotation in the first posture information with a gravity vector as an axis of rotation.

In the correction method according to Additional Remark 4, the second normal vector is calculated by rotating a first normal vector by 90 degrees around the gravity vector as the axis of rotation. For example, when the projection receiving surface is changed from a wall to another wall of the room, the second normal vector can be readily calculated, so that the time required to generate the correction parameter generated based on the second normal vector can be shortened. The period until the projection image having a corrected shape is projected onto the second projection receiving surface can therefore be shortened, so that the user's convenience can be improved.

### Additional Remark 5

The correction method according to any one of Additional Remarks 1 to 3, wherein calculating the second posture information includes calculating the second posture information by reflecting the rotation in the first posture information with a vector perpendicular to a first normal vector and a gravity vector contained in the first posture information as an axis of rotation.

In the correction method according to Additional Remark 5, the second posture information is calculated by reflecting the rotation in the first posture information with a vector perpendicular to the first normal vector and the gravity vector contained the in first posture information as the axis of rotation. For example, when the projection receiving surface is changed from a wall to the ceiling or the floor, the second normal vector can be readily calculated, so that the time required to generate the correction parameter generated based on the second normal vector can be shortened. The period until the projection image having a corrected shape is projected onto the second projection receiving surface can therefore be shortened, so that the user's convenience can be improved.

### Additional Remark 6

A non-transitory computer-readable storage medium storing a program, the program causing a processor provided in a projection apparatus configured to project a projection image onto a projection receiving surface to: calculate, when a rotation operation of the projection apparatus is detected based on an output from a first sensor provided in the projection apparatus, an amount of the rotation of the projection apparatus based on the output from the first sensor; determine whether the projection receiving surface is changed from a first projection receiving surface to a second projection receiving surface different from the first projection receiving surface; calculate second posture information on a posture of the second projection receiving surface based on first posture information on a posture of the first projection receiving surface stored in a storage of the projection apparatus and the amount of the rotation of the projection apparatus; generate a correction parameter used to correct a shape of the projection image based on the calculated second posture information; and cause the projection apparatus to project the projection image having a shape corrected based on the correction parameter onto the second projection receiving surface.

The program according to Additional Remark 6 can provide the same advantages as the correction method according to Additional Remark 1.

What is claimed is:

1. A correction method causing a processor provided in a projection apparatus configured to project a projection image onto a projection receiving surface to:
calculate, when a rotation operation of the projection apparatus is detected based on an output from a first sensor provided in the projection apparatus, an amount of the rotation of the projection apparatus based on the output from the first sensor;
determine whether the projection receiving surface is changed from a first projection receiving surface to a second projection receiving surface different from the first projection receiving surface;
calculate second posture information on a posture of the second projection receiving surface based on first posture information on a posture of the first projection receiving surface stored in a storage of the projection apparatus and the amount of the rotation of the projection apparatus;
generate a correction parameter used to correct a shape of the projection image based on the calculated second posture information; and
cause the projection apparatus to project the projection image having a shape corrected based on the correction parameter onto the second projection receiving surface.

2. The correction method according to claim 1, wherein
determining whether the projection receiving surface is changed to the second projection receiving surface includes comparing the amount of the rotation of the projection apparatus calculated based on the output with a threshold, and determining that the projection receiving surface is changed to the second projection receiving surface when the amount of the rotation is greater than the threshold.

3. The correction method according to claim 1, wherein
determining whether the projection receiving surface is changed to the second projection receiving surface includes determining whether the projection receiving surface is changed to the second projection receiving surface based on a distance to the projection receiving surface measured with a second sensor provided in the projection apparatus.

4. The correction method according to claim 1, wherein
calculating the second posture information includes calculating the second posture information by reflecting the rotation in the first posture information with a gravity vector as an axis of rotation.

5. The correction method according to claim 1, wherein
calculating the second posture information includes calculating the second posture information by reflecting the rotation in the first posture information with a vector perpendicular to a first normal vector and a gravity vector contained in the first posture information as an axis of rotation.

6. A non-transitory computer-readable storage medium storing a program, the program causing a processor provided in a projection apparatus configured to project a projection image onto a projection receiving surface to:
calculate, when a rotation operation of the projection apparatus is detected based on an output from a first sensor provided in the projection apparatus, an amount of the rotation of the projection apparatus based on the output from the first sensor;
determine whether the projection receiving surface is changed from a first projection receiving surface to a second projection receiving surface different from the first projection receiving surface;
calculate second posture information on a posture of the second projection receiving surface based on first posture information on a posture of the first projection receiving surface stored in a storage of the projection apparatus and the amount of the rotation of the projection apparatus;
generate a correction parameter used to correct a shape of the projection image based on the calculated second posture information; and
cause the projection apparatus to project the projection image having a shape corrected based on the correction parameter onto the second projection receiving surface.
